(19) United States
(12) Patent Application Publication
(10) Pub. No.: US 2008/0320016 A1
(43) Pub. Date: Dec. 25, 2008

(54) AGE MATRIX FOR QUEUE DISPATCH ORDER

(75) Inventors: Gaurav Singh, Los Altos, CA (US); Srivatsan Srinivasan, San Jose, CA (US); Lintsung Wong, Santa Clara, CA (US)

Correspondence Address: STEVENS LAW GROUP, P.O.BOX 1667, SAN JOSE, CA, 95109, US

(73) Assignee: Raza Microelectronics, Inc., Cupertino, CA (US)

(21) Appl. No.: 11/847,170

(22) Filed: Aug. 29, 2007

Related U.S. Application Data
(63) Continuation-in-part of application No. 11/830,727, filed on Jul. 30, 2007.
Application No. 11/830,727 is a continuation of application No. 11/820,350, filed on Jun. 19, 2007.

(51) Int. Cl. G06F 17/30; G06F 12/00; G06F 9/30

(52) U.S. Cl. 707/100; 711/104; 712/220; 711/160; 707/E17.044; 711/E12.001; 712/E09.016

(57) ABSTRACT

An apparatus for queue scheduling. An embodiment of the apparatus includes a dispatch order data structure, a bit vector, and a queue controller. The dispatch order data structure corresponds to a queue. The dispatch order data structure stores a plurality of dispatch indicators associated with a plurality of pairs of entries of the queue to indicate a write order of the entries in the queue. The queue controller interfaces with the queue and the dispatch order data structure. Multiple queue structures interfaces with an output arbitration logic and schedule packets to achieve optimal throughput.

### BACKGROUND

A queue hardware structure is used in an ASIC or a processor to store data or control packets prior to issue. There are many different ways to manage the dispatch order, or age, of packets in an scheduling queue. A common queue implementation uses a first-in-first-out (FIFO) data structure. In this implementation, instruction dispatches arrive at the tail, or end, of the FIFO data structure. A look-up mechanism finds the first packet ready for issue from the head, or start, of the FIFO data structure.

Typically, the queue is organized as smaller, discrete structures, with the queue interacting with multiple agents, each with varying bandwidth and throughput requirements. Several schemes exist to achieve a fair, balanced packet scheduling. Commonly, a round-robin (or a variant of round-robin) scheme is adopted in scheduling the packets.

### SUMMARY

Embodiments of a device, system and method are described according to the invention. In one embodiment, the invention is directed to device, system and method described herein with examples configured according to the invention. In one embodiment, the invention provides novel queue allocation that greatly improves queuing arbitration. The invention provides a device, system and method for queue allocation in a queue arbitration system, where a plurality of queues are configured to transmit queue dispatch requests to be arbitrated. A queue controller is provided that is configured to interface with the plurality of queues, to receive queue dispatch requests and to grant queue dispatch requests according to an age matrix protocol.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a plurality of packet scheduling queues with corresponding dispatch order data structures.

FIG. 2 depicts a schematic diagram of one embodiment of a dispatch order data structure in a matrix configuration.

FIG. 3 depicts a schematic diagram of one embodiment of a sequence of data structure states of the dispatch order data structure shown in FIG. 2.

FIG. 4 depicts a schematic diagram of another embodiment of a dispatch order data structure with masked duplicate entries.

FIG. 5 depicts a schematic diagram of one embodiment of a sequence of data structure states of the dispatch order data structure shown in FIG. 4.

FIG. 6 depicts a schematic diagram of another embodiment of a dispatch order data structure in a partial matrix configuration.

FIG. 7 depicts a schematic diagram of one embodiment of a sequence of data structure states of the dispatch order data structure shown in FIG. 6.

FIG. 8 depicts a schematic block diagram of one embodiment of an packet scheduler which uses a dispatch order data structure.

FIG. 9 depicts a simplified representation of FIG. 8.

FIG. 10 depicts a schematic flow chart diagram of one embodiment of a queue operation method for use with the packet scheduler of FIG. 8.

Throughout the description, similar reference numbers may be used to identify similar elements.

### DETAILED DESCRIPTION

The invention is directed to device, system and method described herein with examples configured according to the invention. In one embodiment, the invention provides novel queue allocation that greatly improves queuing arbitration. The invention provides a device, system and method for queue allocation in a queue arbitration system, where a plurality of queues are configured to transmit queue dispatch requests to be arbitrated. A queue controller is provided that is configured to interface with the plurality of queues, to receive queue dispatch requests and to grant queue dispatch requests according to an age matrix protocol. Examples of devices, systems and methods configured according to the invention are illustrated and described below. These examples of the invention, however, are not intended to limit the spirit and scope of the invention. Rather, the spirit and scope of the invention are defined by the appended claims and their equivalents, and also by any subsequent claims submitted in future proceedings or filings.

According to the invention, improved arbitration protocols for granting requests for queuing dispatches according to an age matrix are provided to increase efficiency in throughput of such systems. The invention may additionally include queuing for individual packets within a queue, where age based protocols are used to determine which packets are issued. These separate features can be used alone or in combination with other systems and methods to provide optimal queuing in such systems according to the invention.

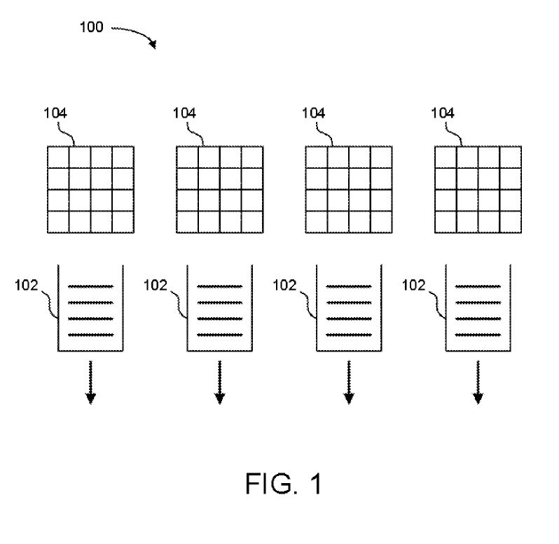

FIG. 1 depicts a schematic block diagram of one embodiment of a plurality of packet scheduling queues 102 with corresponding dispatch order data structures 104. In general, the packet scheduling queues 102 store packets, or some representative indicators of the packets, prior to execution. The location where the packets are stored is referred to as an entry. It should be noted that although the following description references a specific type of queue (i.e., a packet scheduling queue), embodiments may be implemented for other types of queues, such as queuing requests for queue dispatch, queuing individual packets, and other types of queues. The queuing methods for individual packets will first be illustrated and described, then queuing for requests for queue dispatches will be described separately.

Instead of implementing shifting and collapsing operations to continually adjust the positions of the entries in each queue 102, the dispatch order data structure 104 is kept separately from the queue. In one embodiment, each issue queue 102 is a fully-associative structure in a random access memory (RAM) device. The dispatch order data structures 104 are separate control structures to maintain the relative dispatch order, or age, of the entries in the corresponding issue queues 102. An associated packet scheduler may be implemented as a RAM structure or, alternatively, as another type of structure.

In one embodiment, the dispatch order data structures 104 correspond to the queues 102. Each dispatch order data structure 104 stores a plurality of dispatch indicators associated with a plurality of pairs of entries of the corresponding queue 102. Each dispatch indicator indicates a dispatch order of the entries in each pair.

In one embodiment, the dispatch order data structure 104 stores a representation of at least a partial matrix with intersecting rows and columns. Each row corresponds to one of the entries of the queue, and each column corresponding to one of the entries of the queue. Hence, the intersections of the rows and columns correspond to the pairs of entries in the queue. Since the dispatch order data structure 104 stores dispatch, or age, information, and may be configured as a matrix, the dispatch order data structure 104 is also referred to as an age matrix.

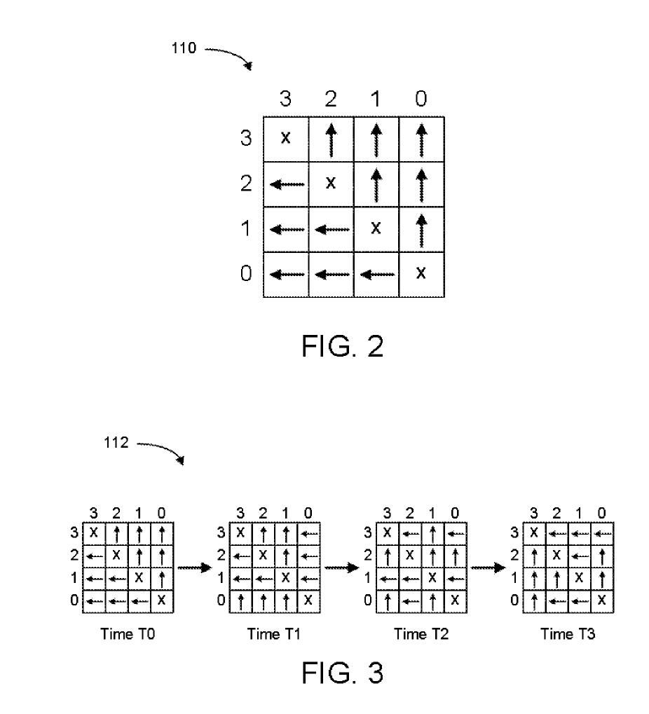

FIG. 2 depicts a schematic diagram of one embodiment of a dispatch order data structure 110 in a matrix configuration. The dispatch order data structure 110 is associated with a specific issue queue 102. The dispatch order of the entries in the queue 102 depends on the relative age of each entry, or when the entry is written into the queue, compared to the other entries in the queue 102. The dispatch order data structure 110 provides a representation of the dispatch order for the corresponding issue queue 102.

The illustrated dispatch order data structure 110 has four rows, designated as rows 0-3, corresponding to entries of the issue queue 102. Similarly, the dispatch order data structure has four columns, designated as columns 0-3, corresponding to the same entries of the issue queue 102. Other embodiments of the dispatch order data structure 110 may include fewer or more rows and columns, depending on the number of entries in the corresponding issues queue 102.

The intersections between the rows and columns correspond to different pairs, or combinations, of entries in the issue queue 102. As described above, each entry of the dispatch order data structure 110 indicates a relative dispatch order, or age, of the corresponding pair of entries in the queue 102. Since there is not a relative age difference between an entry in the queue 102 and itself (i.e., where the row and column correspond to the same entry in the queue 102), the diagonal of the dispatch order data structure 110 is not used or masked. Masked dispatch indicators are designated by an “X.”

For the remaining entries, arrows are shown to indicate the relative dispatch order for the corresponding pairs of entries in the queue 102. As a matter of convention in FIG. 2, the arrow points toward the older entry, and away from the newer entry, in the corresponding pair of entries. Hence, a left arrow indicates that the issue queue entry corresponding to the row is older than the issue queue entry corresponding to the column. In contrast, an upward arrow indicates that the issue queue entry corresponding to the column is older than the issue queue entry corresponding to the row.

For example, Entry_0 of the queue 102 is older than all of the other entries, as shown in the bottom row and the rightmost column of the dispatch order data structure 110 (i.e., all of the arrows point toward the older entry, Entry_0). In contrast, Entry_3 of the queue 102 is newer than all of the other entries, as shown in the top row and the leftmost column of the dispatch order data structure 110 (all of the arrows point away from the newer entry, Entry_3). By looking at all of the dispatch indicators of the dispatch order data structure 110, it can be seen that the dispatch order, from oldest to newest, of the corresponding issue queue 102 is: Entry_0, Entry_1, Entry_2, Entry_3.

FIG. 3 depicts a schematic diagram of one embodiment of a sequence 112 of data structure states of the dispatch order data structure 110 shown in FIG. 2. At time T0, the dispatch order data structure 110 has the same dispatch order as shown in FIG. 2 and described above. At time T1, a new entry is written in Entry_0 of the issue queue 102. As a result, the dispatch indicators of the dispatch order data structure 110 are updated to show that Entry_0 is the newest entry in the issue queue 102. Since Entry_0 was previously the oldest entry in the issue queue 102, all of the dispatch indicators for Entry_0 are updated.

At time T2, a new entry is written in Entry_2. As a result, the dispatch indicators of the dispatch order data structure 110 are updated to show that Entry_2 is the newest entry in the issue queue 102. Since Entry_2 was previously older than Entry_3 and Entry_0 at time T1, the corresponding dispatch indicators for the pairs Entry_2/Entry_3 and Entry_2/Entry_0 are updated, or flipped. Since Entry_2 is already marked as newer than Entry_1 at time T1, the corresponding dispatch indicators for the pair Entry_2/Entry_1 is not changed.

At time T3, a new entry is written in Entry_1. As a result, the dispatch indicators of the dispatch order data structure 110 are updated to show that Entry_1 is the newest entry in the issue queue 102. Since Entry_1 was previously the oldest entry in the issue queue 102 at time T2, all of the corresponding dispatch indicators for Entry_1 are updated, or flipped.

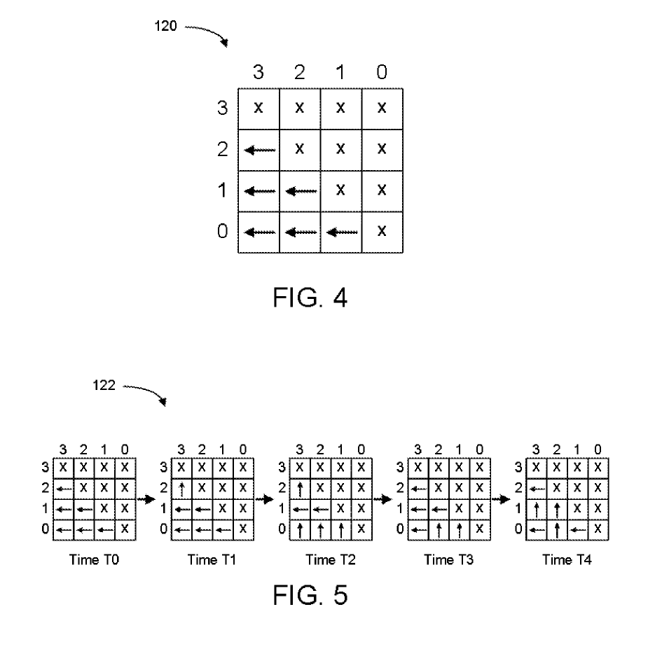

FIG. 4 depicts a schematic diagram of another embodiment of a dispatch order data structure 120 with masked duplicate entries. Since the dispatch indicators above and below the masked diagonal entries are duplicates, either the top or bottom half of the dispatch order data structure 120 may be masked. In the embodiment of FIG. 4, the top portion is masked. However, other embodiments may use the top portion and mask the bottom portion.

FIG. 5 depicts a schematic diagram of one embodiment of a sequence 122 of data structure states of the dispatch order data structure 120 shown in FIG. 4. In particular, the sequence 122 shows how the dispatch indicators in the lower portion of the dispatch order data structure 120 are changed each time an entry in the corresponding queue 102 is changed. At time T1, a new entry is written in Entry_2, and the dispatch indicator for the pair Entry_2/Entry_3 is updated. At time T2, a new entry is written in Entry_0, and the dispatch indicators for all the pairs associated with Entry_0 are updated. At time T3, a new entry is written in Entry_3, and the dispatch indicators for the pairs Entry_3/Entry_0 and Entry_3/Entry_2 are updated. At time T4, a new entry is written in Entry_1, and the dispatch indicators for all of the entries associated with Entry_1 are updated.

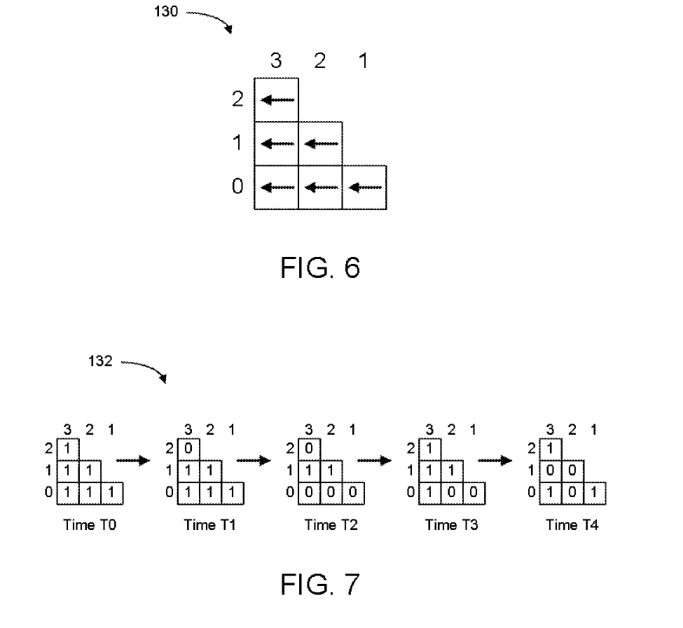

FIG. 6 depicts a schematic diagram of another embodiment of a dispatch order data structure 130 in a partial matrix configuration. Instead of masking the duplicate and unused dispatch indicators, the dispatch order data structure 130 only stores one dispatch indicator for each pair of entries in the queue.

In this embodiment, the partial matrix configuration has fewer entries, and may be stored in less memory space, than the previously described embodiments of the dispatch order data structures 110 and 120. In particular, for an issue queue 102 with a number of entries, N, the dispatch order data structure 130 may store the same number of dispatch indicators, n, as there are pairs of entries, according to the following:

$$n = {C}_{2}^{N} = \frac{N !}{2 ! ( N - 2 ) !}$$

where n designates the number of pairs of entries of the queue 102, and N designates a total number of entries in the queue 102. For example, if the queue 102 has 4 entries, then the number of pairs of entries is 6. Hence, the dispatch order data structure 130 stores six dispatch indicators, instead of 16 (i.e., a 4×4 matrix) dispatch indicators. As another example, an issue queue 102 with 16 entries has 120 unique pairs, and the corresponding dispatch order data structure 130 stores 120 dispatch indicators.

FIG. 7 depicts a schematic diagram of one embodiment of a sequence 132 of data structure states of the dispatch order data structure 130 shown in FIG. 6. However, instead of showing the dispatch indicators as arrows, the illustrated dispatch order data structures 130 of FIG. 7 are shown as binary values. As a matter of convention, a binary “1” corresponds to a left arrow, and a binary “0” corresponds to an upward arrow. However, other embodiments may be implemented using a different convention. Other than using binary values for a limited number of dispatch indicators, the sequence 132 of queue operations for times T0-T4 are the same as described above for FIG. 5.

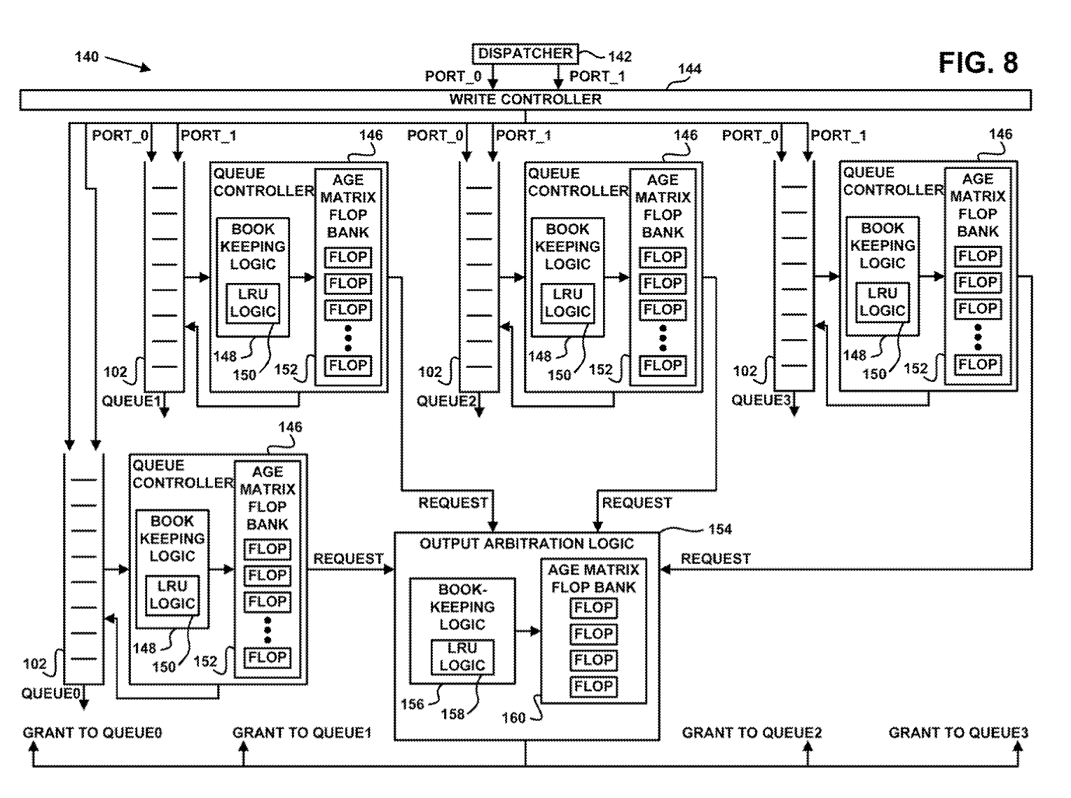

FIG. 8 depicts a schematic block diagram of one embodiment of an packet queue scheduler 140 which uses dispatch order data structures 104 such as one of the dispatch order data structures 110, 120, or 130, one each per queue. It should also be noted that other embodiments of the scheduler 140 may include fewer or more components than are shown in FIG. 8.

The illustrated scheduler 140 includes four queues 102, a dispatcher 142, write controller 144 and queue controllers 146. The dispatcher 142 is configured to issue one or more queue operations to insert new entries in the queue 102. In one embodiment, the dispatcher 142 dispatches up to two packets per cycle to each issue queue 102. The queue controller 146 also interfaces with the queue 102 to update a dispatch order data structure 104 in response to a queue operation to insert a new entry in the queue 102.

In order to receive two packets per cycle, each issue queue 102 has two write ports, which are designated as Port_0 and Port_1. Alternatively, the dispatcher 142 may dispatch a single packet on one of the write ports. In other embodiments, the issue queue 102 may have one or more write ports. If multiple packets are dispatched at the same time to multiple write ports, then the write ports may have a designated order to indicate the relative dispatch order of the packets which are issued together. For example, an packet issued on Port_0 may be designated as older than an packet issued in the same cycle on Port_1. In one embodiment, write addresses are generated internally in each issue queue 102.

The queue controller 146 keeps track of the dispatch order of the entries in the issue queue 102 to determine which entries can be overwritten (or evicted). In order to track the dispatch order of the entries in the queue 102, the queue controller 146 includes book-keeping logic 148 with least recently used (LRU) logic 150. The queue controller 146 also includes an age matrix flop bank 152. In one embodiment, the flop bank 152 includes a plurality of flip-flops. Each flip-flop stores a bit value indicative of the dispatch order of the entries of a corresponding pair of entries. In other words, each flip-flop corresponds to a dispatch indicator, and the flop bank 152 implements the dispatch order data structure 104. The bit value of each flip-flop is a binary bit value. In one embodiment, a logical high value of the binary bit value indicates one dispatch order of the pair of entries (e.g., the corresponding row is older than the corresponding column), and a logical low value of the binary bit value to indicate a reverse dispatch order of the pair of entries (e.g., the corresponding column is older than the corresponding row). When a dispatch indicator is updated in response to a new packet written to the queue 102, the book-keeping logic 148 is configured to potentially flip the binary bit value for the corresponding dispatch indicators. As described above, the number of flip-flops in the flop bank 152 may be determined by the number of pairs (e.g., combinations) of entries in the queue 102.

In order to determine which entries may be overwritten in the queue 102, the book-keeping logic 148 includes least recently used (LRU) logic 148 to implement a LRU replacement strategy. In one embodiment, the LRU replacement strategy is based, at least in part, on the dispatch indicators of the corresponding dispatch order data structure 104 implemented by the flop bank 152. As examples, the LRU logic 148 may implement a true LRU replacement strategy or other strategies like pseudo LRU or random replacement strategies. In a true LRU replacement strategy, the LRU entries in the queue 102 are replaced. The LRU entries are designated by LRU replacement addresses. However, generating the LRU replacement addresses, which is a serial operation, can be logically complex. A pseudo LRU replacement strategy approximates the true LRU replacement strategy using a less complicated implementation.

When the dispatcher dispatches a new entry to the queue 102 as a part of a queue operation, the queue 102 interfaces with the queue controller 146 to determine which existing entry to discard to make room for the newly dispatched entry. In some embodiments, the book-keeping logic 148 uses the age matrix flop bank 152 to determine which entry to replace based on the absolute dispatch order of the entries in the queue 102. However, in other embodiments, it may be useful to identify an entry to discard from among a subset of the entries in the queue 102.

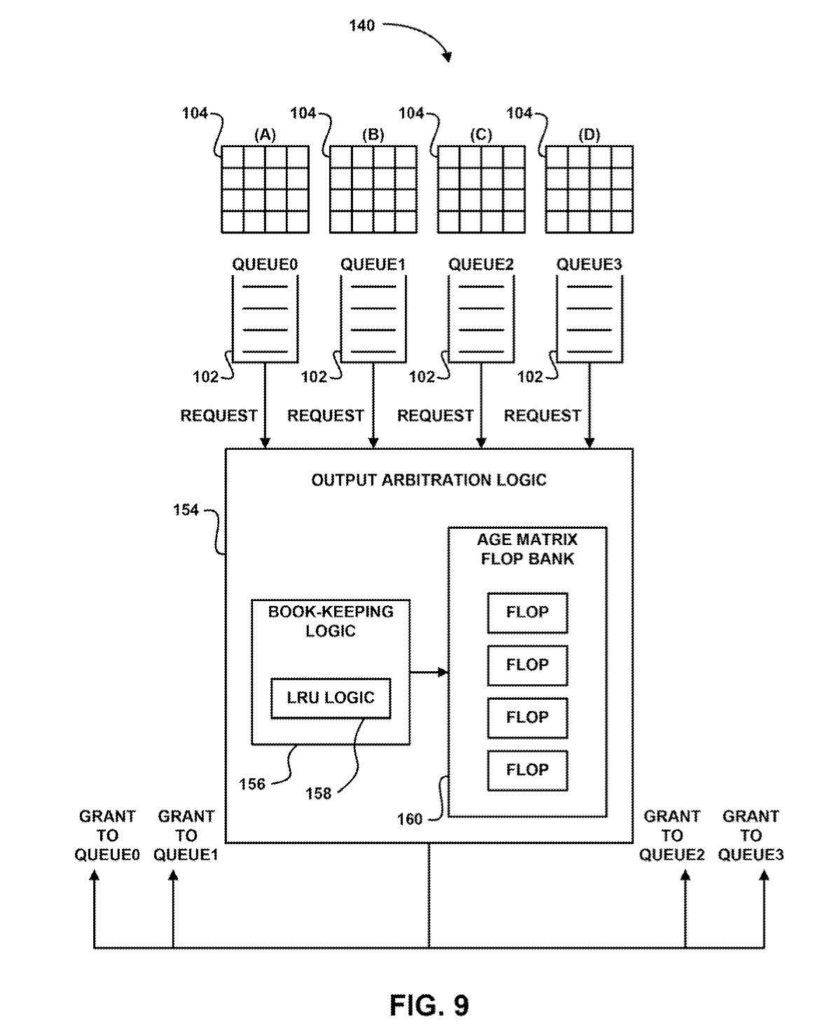

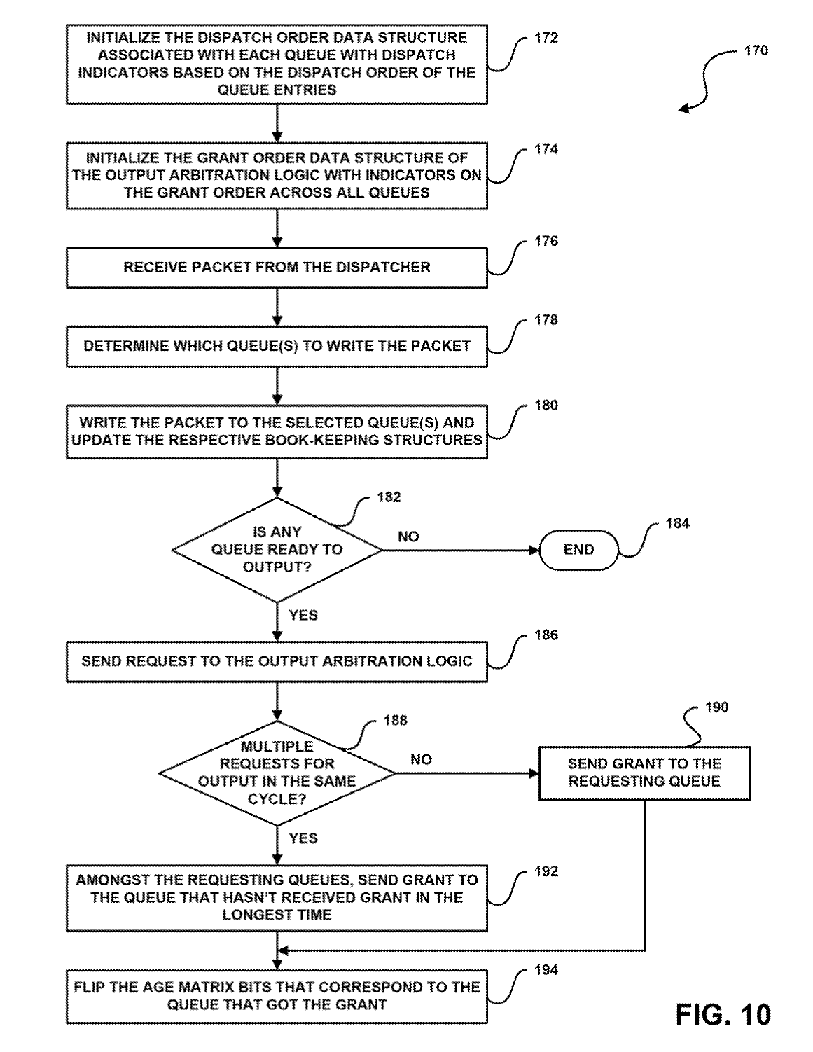

When a queue is ready to schedule the packet, it sends a request to the output arbitration logic 154. The arbitration logic 154 maintains a separate book-keeping structure 156 which could use a LRU scheme 158 (similar to LRU logic 150) and age matrix flop bank 160 (similar to flop bank 152, but the age is applicable across the entire queue as opposed to each entry in the queues) and grant access to the queue. If multiple queues sends request at the same time, the arbitration logic 154 grants access to the queue that hasn't received the grant for the longest time. FIG. 9 is a simplified illustration of FIG. 8. In some embodiments, the flop bank bits could be updated after granting the access to the queue. In other embodiments, the book-keeping logic, and age management could be implemented using alternate approaches. FIG. 10 depicts a schematic flow chart diagram of one embodiment of a queue operation method 170 for use with the packet queue scheduler 140 of FIG. 8. Although the tracking method 170 is described with reference to the packet queue scheduler 140 of FIG. 8, other embodiments may be implemented in conjunction with other schedulers.

In the illustrated queue operation method 170, the queue controller 146 initializes 172 the dispatch order data structure 104. As described above, the queue controller 146 may initialize the dispatch order data structure 104 with a plurality of dispatch indicators based on the dispatch order of the entries in the queue 102. In this way, the dispatch order data structure 104 maintains an absolute dispatch order for the queue 102 to indicate the order in which the entries are written into the queue 102. Although some embodiments are described as using a particular type of dispatch order data structure 104 such as the age matrix, other embodiments may use other implementations of the dispatch order data structure.

The illustrated queue operation method 170 also initializes the grant order of output arbitration logic 154 of FIG. 8 and FIG. 9 with a plurality of indicators based on the desired initial order of grant. Although some implementations may choose to initialize the grant indicators in a particular way, other embodiments may use other implementations to initialize the grant order data structure.

Referring to FIG. 9, showing the queues 102 (a)-(d) and dispatch order data structures 104 (a)-(d) as distinguishable. Each of the data structures 104 (a)-(d) can separately be dispatched in queues 102 (a)-(d) respectively. The output from the queues then go to arbitration logic 103, which may be hardware, firmware or software, for output arbitration. According to one embodiment of the invention, different types of arbitration operations can be utilized in addition to the age matrix operations described above. Conventional round-robin operations can be implemented in such a device, system and method configured according to the invention, by incorporating the features of round-robin and related operations.

Alternatively, according to another embodiment of the invention, the age-matrix operations can be used to determine which queue can dispatch to an output. Still referring to FIG. 9, age matrix operations described above can be applied to the queue output arbitration, allowing for an increased fair treatment to queue requests at the queue output. Within each queue, the oldest entry could be chosen using dispatch order data structure 152.

The age-matrix operations discussed above are directed generally to the age of the separate packets in the queues. If the queues are intermittently empty and full at different times, the age matrix is beneficial because it takes care of packets in a time basis. This is useful so that the packets do not wait too long to be serviced. Moreover, this prevents the system from inefficiently rationing arbitration time to that it is not unduly wasted on empty queues. These features are greatly beneficial to the queue dispatch arbitration, particularly where queues are intermittently full and empty. In many computer processing units, this is often the case. Thus, in this alternative embodiment of the invention, age matrix operations are applied to the queue dispatch arbitration to improve the queue dispatch. Again, this may be applied in both cases where age matrix are applied to the packets in the queue, and also applications where the queues are not configured internally with age matrix functions directed to the individual packets.

Still referring to FIG. 9, the dispatch order data structure 104 (a)-(d) may be as described above, or the queues may be unstructured with respect to the packets that are internal to the queues. According to one embodiment of the invention, the arbitration logic 103 is configured with age matrix functions that enable the arbitration for the requests and grants in an age matrix manner as described above with respect to the individual packets within the queues in the embodiment described above. In this embodiment, requests are received by arbitration logic 154 as requested by the individual queues. The arbitration logic then grants requests by sending a grant response to individual queues 102(a)-(d) according to age matrix protocols. For example, the age matrix protocol may arbitrate in a manner that chooses the queue that LEAST recently was granted a request from the arbitration logic. This provides the age matrix functionality according to the invention to the queue dispatch requests. According to the invention, queue dispatch requests can then be arbitrated in a more fair manner than conventional methods. Again, this method can be configured in a system that uses age matrix operations to arbitrate among individual packets inside the queue, and also systems that do not.

In contrast to age matrix operations, round-robin operations rotate among queues on a non-discriminatory basis. In practice where it has been found that in a situation where queues are consistently full, round-robin operations are best to optimize the throughput of a busy packet system. Since all queues are given equal attention in the round-robin framework, they equally empty. This can have benefit for a system that, again, has queues that are each consistently full. Such a process can be used in conjunction with age matrix operations discussed above that are solely used to arbitrate individual packets within a queue. However, in yet another embodiment of the invention, a combination of age matrix operations used within the queues and also age matrix operations used in the arbitration logic to arbitrate among the queues themselves is also possible.

FIG. 10 illustrates an embodiment of a method of dispatching to multiple queues and arbitrating queue requests that are received by arbitration logic from queues. In step 172, the arbitrator is initialized. In step 174, the arbitrator receives requests for queue transmission, or queue dispatch from one or more queues. In step 176, age matrix protocols are applied to incoming requests for queue transmission. According to the invention, in step 178, a determination is made whether a queue or which queue has received the least recent grant. This provides fairness in the arbitration above conventional methods, such as round robin or other protocols. If a queue transfer request is received from a queue that has received a grant LEAST recently compared to other queues, then a request for queue transmission is granted in step 180.

The illustrated queue operation method 170 continues as the dispatcher (142 of FIG. 8) dispatches packet(s) 176 to the queue(s) 102. As explained above, the write controller (144 of FIG. 8) identifies the queue into which the packet(s) has/have to be written. The queue controller 146 associated with each queue 102, selects an existing entry of the queue 102 to be discarded from all of the entries in the queue 102 or from a subset of the entries in the queue 102.

Packet(s) is/are written to the queue(s) identified 172 and the corresponding book-keeping structures (148 of FIG. 8) are updated 180.

If and when a queue 102 is ready to issue the packet, the queue's book-keeping logic 148 sends 186 a request to the output arbitration logic (154 of FIG. 8 and FIG. 9). If no queue is ready to issue a request, the flow ends.

If the output arbitration logic receives 188 multiple requests simultaneously, the arbitration logic prioritizes one request over the other. If there is only one outstanding request, the output arbitration logic (154 of FIG. 8 and FIG. 9) grants 190 the request. In some embodiments, the arbitration logic may choose not to issue the grant.

For multiple requests, the output arbitration logic (154 of FIG. 8 and FIG. 9) prioritizes the request from the queue that hasn't received a grant in the longest time (amongst the requesting queues) and sends 192 the grant. In other embodiments, the grant may be issued to queues in any other order of priority or may grant without any priority. After issuing the grant, the age matrix bits of the grant order data structure are flipped 194. In some embodiments, the data structure could be updated in different manner. Whereas in other embodiments, the data structures may not be updated.

It should be noted that embodiments of the methods, operations, functions, and/or logic may be implemented in software, firmware, hardware, or some combination thereof. Additionally, some embodiments of the methods, operations, functions, and/or logic may be implemented using a hardware or software representation of one or more algorithms related to the operations described above. To the degree that an embodiment may be implemented in software, the methods, operations, functions, and/or logic are stored on a computer-readable medium and accessible by a computer processor.

As one example, an embodiment may be implemented as a computer readable storage medium embodying a program of machine-readable packets, executable by a digital processor, to perform operations to facilitate queue allocation. The operations may include operations to store a plurality of dispatch indicators corresponding to pairs of entries in a queue. Each dispatch indicator is indicative of the dispatch order of the corresponding pair of entries. The operations also include operations to store a bit vector comprising a plurality of mask values corresponding to the dispatch indicators of the dispatch order data structure, and to perform a queue operation on a subset of the entries in the queue. The subset excludes at least some of the entries of the queue based on the mask values of the bit vector. Other embodiments of the computer readable storage medium may facilitate fewer or more operations.

Embodiments of the invention also may involve a number of functions to be performed by a computer processor such as a central processing unit (CPU), a graphics processing unit (GPU), or a microprocessor. The microprocessor may be a specialized or dedicated microprocessor that is configured to perform particular tasks by executing machine-readable software code that defines the particular tasks. The microprocessor also may be configured to operate and communicate with other devices such as direct memory access modules, memory storage devices, Internet related hardware, and other devices that relate to the transmission of data. The software code may be configured using software formats such as Java, C++, XML (Extensible Mark-up Language) and other languages that may be used to define functions that relate to operations of devices required to carry out the functional operations related described herein. The code may be written in different forms and styles, many of which are known to those skilled in the art. Different code formats, code configurations, styles and forms of software programs and other means of configuring code to define the operations of a microprocessor may be implemented.

Within the different types of computers, such as computer servers, that utilize the invention, there exist different types of memory devices for storing and retrieving information while performing some or all of the functions described herein. In some embodiments, the memory/storage device where data is stored may be a separate device that is external to the processor, or may be configured in a monolithic device, where the memory or storage device is located on the same integrated circuit, such as components connected on a single substrate. Cache memory devices are often included in computers for use by the CPU or GPU as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform certain functions when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. Embodiments may be implemented with various memory and storage devices, as well as any commonly used protocol for storing and retrieving information to and from these memory devices respectively.

Although the operations of the method(s) herein are shown and described in a particular order, the order of the operations of each method may be altered so that certain operations may be performed in an inverse order or so that certain operations may be performed, at least in part, concurrently with other operations. In another embodiment, packets or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An apparatus for queue allocation, the apparatus comprising:
a queue to store a plurality of entries;
a dispatch order data structure corresponding to the queue, the dispatch order data structure to store a plurality of dispatch indicators associated with a plurality of pairs of entries of the queue to indicate a dispatch order of the entries in each pair; and
a queue controller to interface with the queue and the dispatch order data structure, the queue controller to update the dispatch order data structure in response to a queue operation to insert a new entry in the queue.

2. The apparatus according to claim 1, the dispatch order data structure comprising a representation of at least a partial matrix with intersecting rows and columns, each row corresponding to one of the entries of the queue and each column corresponding to one of the entries of the queue, the intersections of the rows and columns corresponding to the pairs of entries in the queue.

3. The apparatus according to claim 1, further comprising a flop bank with a plurality of flip-flops, each flip-flop to store a bit value indicative of the dispatch order of the entries of a corresponding pair of entries.

4. The apparatus according to claim 3, the bit value comprising a binary bit value, a logical high value of the binary bit value to indicate the dispatch order of the pair of entries, and a logical low value of the binary bit value to indicate a reverse dispatch order of the pair of entries.

5. The apparatus according to claim 4, the queue controller further comprising book-keeping logic to interface with the dispatch order data structure, the book-keeping logic to flip the binary bit value for at least one of the dispatch order indicators in response to the queue operation to write the new entry in the queue.

6. The apparatus according to claim 3, the flop bank comprising a number of flip-flops, n, according to the following:
$$n = {C}_{2}^{N} = \frac{N !}{2 ! ( N - 2 ) !}$$
where n designates the number of pairs of entries of the queue, and N designates a total number of entries in the queue.

7. The apparatus according to claim 1, further comprising a random access memory (RAM) device to store the queue and the dispatch order data structure, wherein the queue comprises a fully associative RAM structure and the dispatch order data structure comprises a control structure separate from the fully associative RAM structure.

8. The apparatus according to claim 1, the queue controller further comprising address logic to facilitate translation of an address corresponding to the queue operation.

9. The apparatus according to claim 1, further comprising a dispatcher coupled to the queue, the dispatcher to dispatch the queue operation to insert the new entry in the queue, the fill level logic further configured to communicate the early indication to the dispatcher.

10. The apparatus according to claim 1, the queue controller further comprising least recently used (LRU) logic, the LRU logic to implement a queue operation replacement strategy for the queue based on the dispatch order data structure.

11. The apparatus according to claim 10, the queue operation replacement strategy comprising a true LRU replacement strategy to replace a LRU entry of the queue with the new entry.

12. A method for tracking a dispatch order of queue entries in a queue, the method comprising:
storing a plurality of entries in the queue;
identifying pairs of entries in the queue, each pair comprising two of the entries in the queue;
storing a plurality of dispatch indicators corresponding to the pairs of entries, each dispatch indicator indicative of the dispatch order of the corresponding pair of entries; and
dispatching a queue entry from the queue according to at least one of the dispatch indicators associated with the queue entry.

13. The method according to claim 12, further comprising storing the dispatch indicators in a dispatch order data structure corresponding to a representation of at least a partial matrix with intersecting rows and columns, each row corresponding to one of the entries of the queue and each column corresponding to one of the entries of the queue, the intersections of the rows and columns corresponding to the pairs of entries in the queue.

14. The method according to claim 12, further comprising storing the dispatch indicators in a plurality of flip-flops of a flop bank, each flip-flop comprising a bit value indicative of the dispatch order of the corresponding pair of entries.

15. The method according to claim 14, further comprising flipping the bit value from a first logical state to a second logical state in response to the dispatched queue entry.

16. A computer readable storage medium embodying a program of machine-readable packets, executable by a digital processor, to perform operations to facilitate queue allocation, the operations comprising:
storing a plurality of entries in the queue;
identifying pairs of entries in the queue, each pair comprising two of the entries in the queue;
storing a plurality of dispatch indicators corresponding to the pairs of entries, each dispatch indicator indicative of the dispatch order of the corresponding pair of entries; and
dispatching a queue entry from the queue according to at least one of the dispatch indicators associated with the queue entry.

17. The computer readable storage medium according to claim 16, the operations further comprising an operation to store the dispatch indicators in a dispatch order data structure corresponding to a representation of at least a partial matrix with intersecting rows and columns, each row corresponding to one of the entries of the queue and each column corresponding to one of the entries of the queue, the intersections of the rows and columns corresponding to the pairs of entries in the queue.

18. The computer readable storage medium according to claim 16, the operations further comprising an operation to flip a bit value of at least one of the dispatch indicators from a first logical state to a second logical state in response to the dispatched queue entry.

19. A computer readable storage medium embodying a program of machine-readable packets, executable by a digital processor, to perform operations to manage a dispatch order of a plurality of entries of a queue, the operations comprising:
writing a new entry in the queue;
assigning a matrix line to the new entry, the matrix line intersecting with another matrix line associated with another entry in the queue; and
assigning a bit value to a dispatch indicator at the intersection of the matrix lines to indicate a dispatch order of the corresponding entries in the queue.

20. The computer readable storage medium according to claim 19, the operations further comprising an operation to implement a least recently used (LRU) replacement strategy for the queue based on the dispatch indicator for the corresponding entries in the queue.

21. An apparatus for queue allocation in a queue arbitration system, the apparatus comprising:
a plurality of queues configured to transmit queue dispatch requests to be arbitrated; and
a queue controller configured to interface with the plurality of queues, to receive queue dispatch requests and to grant queue dispatch requests according to an age matrix protocol.

22. An apparatus according to claim 1, wherein the age matrix protocol includes an arbitration method for granting queue dispatch requests to queues having been the least recently granted a queue dispatch request.
